(19) United States
(12) Patent Application Publication
(10) Pub. No.: US 2004/0169734 A1
(43) Pub. Date: Sep. 2, 2004

(54) Electronic camera extracting a predetermined number of images from a plurality of images generated by continuous shooting, and method for same

(75) Inventor: Kazuya Umeyama, Edogawa-ken (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/772,383

(22) Filed: Feb. 6, 2004

(30) Foreign Application Priority Data
Feb. 14, 2003 (JP) 2003-036920

(51) Int. Cl. H04N 5/225

(52) U.S. Cl. 348/218.1

(57) ABSTRACT

The electronic camera has a release switch, an image pickup part, an extraction processing part, and an image composition part. The image pickup part performs continuous shooting according to an operation to the release switch to generate data of plural images in a multi-shooting mode. The extraction processing part changes an extracting rate according to the number of images generated and extracts data of a predetermined number of images from the generated data. The image composition part arranges the extracted image data to generate a composite image. Therefore, when the predetermined number of images are extracted at such intervals that intervals at which the images have been shot become substantially uniform, the first and last frame images in the composite image will coincide with ones which have been shot at the beginning and end of the continuous shooting. That is, the total shooting time can be arbitrarily set.

### CROSS REFERENCE TO RELATED APPLICATION

This application is based upon and claims the benefit of priority from Japanese Patent Application No. 2003-036920, filed on Feb. 14, 2003, the entire contents of which are incorporated herein by reference.

### BACKGROUND OF THE INVENTION

1. Field of the Invention

The present invention relates to an electronic camera having a continuous shooting mode.

2. Description of the Related Art

In general, an electronic camera has a single-shooting mode for shooting one frame when a shutter button is pressed and a continuous shooting mode. In the continuous shooting mode, a shooting operation is repeated while a shutter button is pressed to shoot a plurality of frames continuously. In addition to the ordinary continuous shooting mode, a multi-shooting mode is known as a type of continuous shooting mode. In the multi-shooting mode, images in a plurality of shot frames are arranged and composited into one image (disclosed in Japanese Examined Patent Application Publication No. Hei 11-88824, for example).

In the present specification, one image composited in the multi-shooting mode is simply referred to as composite image, and an image in one frame generated by continuous shooting is simply referred to as single frame image. Image data of a composite image is simply referred to as composite image data, and image data of a single frame image is simply referred to as single frame image data.

An electronic camera having the continuous shooting mode frequently employs an image sensor which can be switched between a motion image mode and a still image mode. Normally, the frame rate of an image sensor in the motion image mode is unique to the sensor such as 30 fps (frame per second), so that it is not possible to set arbitrary frame rate.

Therefore, the shooting interval (the interval at which frame images are shot) of a camera in the conventional multi-shooting mode is unique to the camera, and it is not possible to set the shooting interval arbitrarily in accordance with an expected moving speed of an object. In this case, a problem may arise that a composite image includes unnecessary frame images that are substantially the same as their respective preceding and succeeding frame images.

If the shooting interval is fixed, total shooting time (from a time at which the first single frame of a composite image is shot to a time at which the last single frame image thereof is shot) is determined depending on how may frames are arranged in the composite image. With a fixed total shooting time, for example, when a swing of a golf club or a pitching motion of a baseball player is shot, it is not possible to make the beginning and end of the swing (or pitching) coincide with the beginning and end of the total shooting time. This may cause a problem that the composite image does not include all of the frame images of the swing because the shooting terminates before the swing completes. Also, there may be a similar problem that the composite image includes many unnecessary frame images which are taken after the swing because the swing completes before the shooting terminates.

### SUMMARY OF THE INVENTION

It is an object of the invention to enables arbitrary setting of a total shooting time in a multi-shooting mode of an electronic camera.

The electronic camera of the invention has a multi-shooting mode in which data of a predetermined number of images generated by continuous shooting is arranged and composited (combined) to generate data of a single composite image. Note that the predetermined number of images herein may be referred to as the number of frames which are arranged in a composite image (or the number of arranged frames). According to one aspect of the invention, an electronic camera has a release switch, an image pickup part, an extraction processing part, and an image composition part. The release switch is for instructing the execution of a shooting operation. When the electronic camera is in the multi-shooting mode, the image pickup part performs continuous shooting in accordance with an operation to the release switch to generate data of a plurality of images. The extraction processing part changes an extracting rate according to the number of the images generated by the image pickup part, and extracts data of the predetermined number of images from the generated data of the images according to the changed extracting rate. The image composition part arranges and composites the extracted data of the predetermined number of images to generate the data of the single composite data.

The release switch may sometimes be referred to as release button. The image pickup part corresponds to, for example, a combination of a shooting lens, a CCD, an analog signal processing part, a timing generator, and a focusing motor. The extracting rate may sometimes be referred to as image extracting interval. The extraction processing part has a function of an MPU for determining the image extracting interval and extracting data of frame images according to the image extracting interval and a function of an MPU for calculating differences between frame images in data and extracting data of frame images in ascending order of the differences, for example. The image composition part has, for example, a function of an image processing part for generating composite image data using the extracted data of frame images.

In the electronic camera as described above, it is preferred that the extraction processing part performs the extraction at such intervals that intervals at which images in extracted data have been shot become substantially uniform.

In another aspect of the invention, an electronic camera has a release switch, an image pickup part, a variation calculating part, an extraction processing part, and an image composition part. The release switch is for instructing the execution of a shooting operation. When the electronic camera is in the multi-shooting mode, the image pickup part performs continuous shooting in accordance with an operation to the release switch to generate data of a plurality of images. The variation calculating part calculates a difference between frame images in the data generated by the image pickup part. The difference represents an amount of variation (movement) in an object. The extraction processing part extracts data of the predetermined number of images from the data of the plurality of images at such intervals that the smaller the differences between frame images, the longer the intervals. For example, the extraction may be performed such that data of frame images is extracted in ascending order of the differences between the frame images. The image composition part arranges and composites the extracted data of the images to generate the data of the single composite image.

In the electronic camera as described above, the extraction processing part may preferably extract the data of the predetermined number of images in ascending order of the differences between the frame images.

In another aspect of the invention, an electronic camera has a release switch, an image pickup part, a variation calculating part, an extraction processing part, and an image composition part. The release switch is for instructing the execution of a shooting operation. When the electronic camera is in the multi-shooting mode, the image pickup part performs continuous shooting according to an operation to the release switch to generate data of a plurality of images. The variation calculating part selects the data of the predetermined number or more of images from the generated data of the images according to the number of images generated by the image pickup part, and calculates a difference between frame images in the selected data. The difference represents an amount of variation in an object. The extraction processing part extracts the data of the predetermined number of images from the data of the plurality of images at such intervals that the smaller the difference between the frame images, the longer the intervals. The image composition part arranges and composites the extracted data of the images to generate the data of the single composite image.

In another aspect of the invention, an electronic camera has a release switch, an image pickup part, an extraction processing part, and an image composition part. The release switch is for instructing the execution of a shooting operation. When the electronic camera is in the multi-shooting mode, the image pickup part performs continuous shooting according to an operation to the release switch to generate data of a plurality of images. In the multi-shooting mode the extraction processing part extracts the data of the predetermined number of images from the data of the plurality of images at such intervals that an Nth frame image data to be extracted is generated by shooting at a time of an Xth power of (N-1) where X is more than zero when a first frame image data to be extracted is assumed to be generated by shooting at a time zero. The image composition part arranges and composites the extracted data of the images to generate the data of the single composite image.

In another aspect of the invention, an electronic camera has a release switch, an image pickup part, an extraction processing part, and an image composition part. When the electronic camera is in the multi-shooting mode, the release switch instructs start and end of continuous shooting. The image pickup part performs the continuous shooting according to an operation to the release switch to generate data of a plurality of images in the multi-shooting mode. The extraction processing part extracts data of the predetermined number of images from the data of a plurality of images in such a manner that the data extracted includes data of images shot at the start and end of the continuous shooting. The image composition part arranges and composites the extracted data of the predetermined number of images to generate the data of the single composite image.

The electronic camera described above may be preferably configured that the extraction processing part changes an extracting rate according to the number of images generated by the image pickup part and extracts the data of the predetermined number of images from the generated data of the images according to the changed extracting rate.

Alternatively, the electronic camera may be provided with a variation calculating part that calculates a difference between frame images in the data of the images generated by the image pickup part. The difference represents an amount of variation in an object. In this case the extraction processing part performs the data extraction such that the smaller the difference, the longer the intervals.

The image generation method of the invention is for generating data of a single composite image by arranging and compositing data of a predetermined number of images generated by continuous shooting. In one aspect of the image generation method of the invention, the method includes the steps of: performing continuous shooting to generate data of a plurality of images; changing an extracting rate according to the number of images generated and extracting the data of the predetermined number of images from the generated data of the images according to the changed extracting rate; and generating the data of the single composite image by arranging and compositing the extracted data of the images.

In another aspect of the image generation method of the invention, the method includes the steps of: generating data of a plurality of images by continuous shooting; calculating a difference between frame images in the generated data, the difference representing an amount of variation in an object; extracting the data of the predetermined number of images from the generated data of the images at such intervals that the smaller the difference between the frame images, the longer the intervals; and generating the data of the single composite image by arranging and compositing the extracted data.

In another aspect of the image generation method of the invention, the method includes the steps of: generating data of a plurality of images by continuous shooting; selecting data of the predetermined number or more of images from the generated data of the images according to the number of images generated, and calculating a difference between frame images in the selected data, the difference representing an amount of variation in an object; extracting data of the predetermined number of images from the generated data of the images at such intervals that the smaller the difference between the frame images, the longer the intervals; and generating the data of the single composite image by arranging and compositing the extracted data of the images.

In another aspect of the image generation method of the invention, the method includes the steps of: generating data of a plurality of images by continuous shooting; extracting data of the predetermined number of images from the generated data of the images, the extraction being performed at such intervals that an Nth frame image data to be extracted is generated by shooting at a time of an Xth power of (N-1) where X is more than zero when a first frame of image data to be extracted is assumed to be generated by shooting at a time zero; and generating the data of the single composite image by arranging and compositing the extracted data of the images.

In another aspect of the image generation method of the invention, the method includes the steps of: instructing start and end of continuous shooting; generating data of a plurality of images by the continuous shooting according to the instruction; extracting the data of the predetermined number of images from the data of the plurality of images in such a manner that the data extracted includes data of images shot at the start and end of the continuous shooting; and generating the data of the single composite image by arranging and compositing the extracted data of the images.

### BRIEF DESCRIPTION OF THE DRAWINGS

The nature, principle, and utility of the invention will become more apparent from the following detailed description when read in conjunction with the accompanying drawings in which like parts are designated by identical reference numbers and in which:

FIG. 1 is a block diagram showing a configuration of an electronic camera according to an embodiment of the invention;

FIG. 2 is a flow chart showing operations of the electronic camera of the embodiment; and

FIG. 3 is an illustration showing an example of a composite image created in a multi-shooting mode.

### DESCRIPTION OF THE PREFERRED EMBODIMENT

Hereinafter, a description will be given of an embodiment of the invention with reference to the accompanying drawings.

### CONFIGURATION OF EMBODIMENT

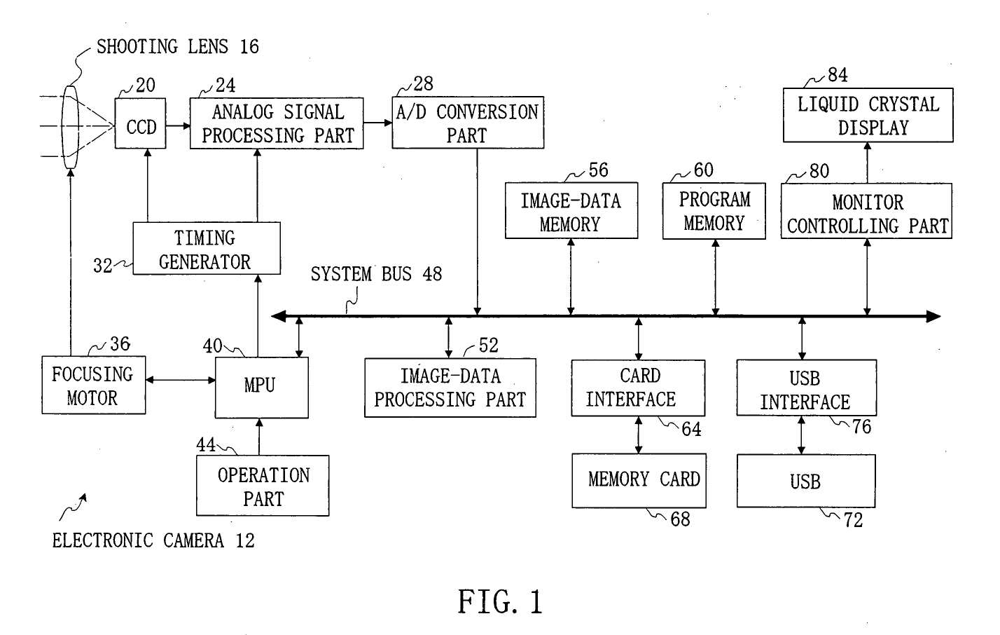

FIG. 1 is a block diagram of an electronic camera of the present embodiment. As illustrated, an electronic camera 12 is constituted of a shooting lens 16, a CCD (image sensor) 20, an analog signal processing part 24, an analog-to-digital conversion part 28, a timing generator 32, a focusing motor 36, an MPU (Micro Processor Unit) 40, an operation part 44, a system bus 48, an image processing part 52, an image-data memory (RAM) 56, a program memory (ROM) 60, a card interface 64, a replaceable memory card (recording medium) 68, a USB (Universal Serial Bus) 72, a USB interface 76, a monitor control part 80, and an LCD(Liquid Crystal Display) 84.

The analog signal processing part 24 and the analog-to-digital conversion part 28 perform clamp processing, sensitivity correction processing, and analog-to-digital conversion to generate digital image data.

The MPU 40 performs system control of the electronic camera 12.

The operation part 44 has setting buttons such as a power button, a shooting mode selection button, a shooting condition input button, and a release button (which are not shown).

The primary characteristics of the electronic camera 12 of the present embodiment are functions of the MPU 40 and the image processing part 52 in a multi-shooting mode which will be described later, and functions of the remaining parts are substantially the same as those of conventional electronic cameras.

### DESCRIPTION OF OPERATIONS OF PRESENT EMBODIMENT

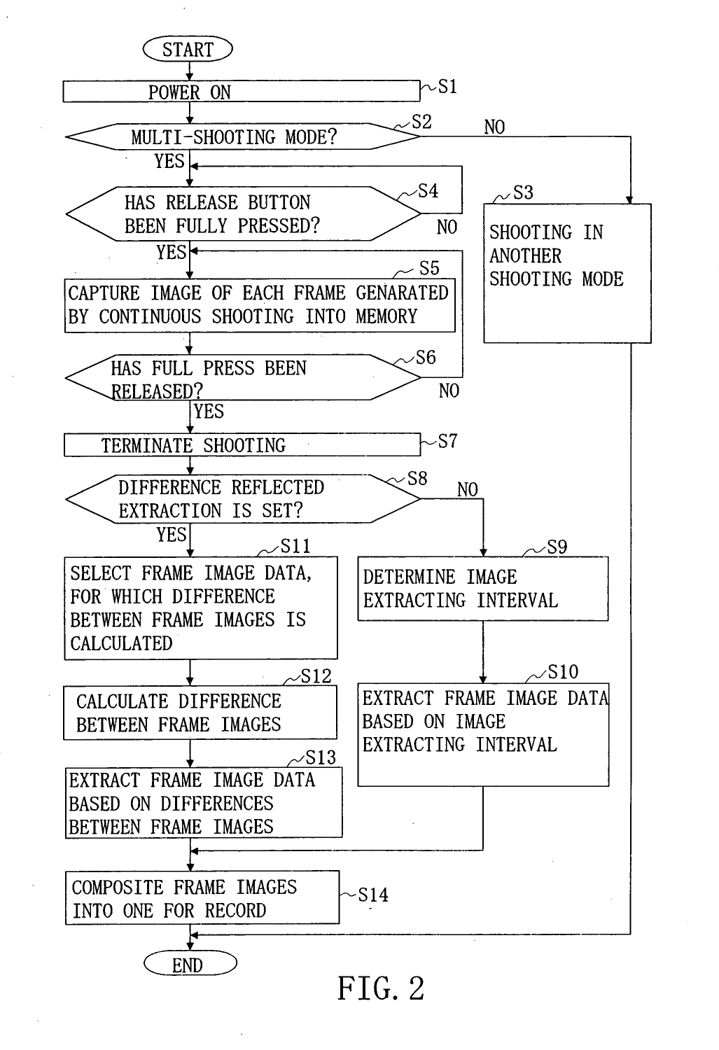

FIG. 2 is a flow chart showing operations of the electronic camera 12 of the present embodiment. Operations of the electronic camera 12 will be hereinafter described according to step numbers shown in the drawing.

[Step S1]

When the power button of the electronic camera 12 is pressed, power-on processing is performed. Thereafter, the user operates the buttons on the operating part 44 to set a shooting mode and so on.

[Step S2]

The MPU 40 determines whether a multi-shooting mode is set or not. In the multi-shooting mode, the process proceeds to step S4. In other shooting modes (such as a single shooting mode), the process proceeds to step S3.

[Step S3]

Shooting is performed in the set shooting mode. This is a known operation, therefore, a description thereon will be omitted here.

[Step S4]

The MPU 40 stands by until the release button is fully pressed. When the button is fully pressed, the process proceeds to step S5.

[Step S5]

The MPU 40 drives the CCD 20 with an electronic shutter in synchronism with the full press on the release button to start continuous shooting at a preset frame rate (e.g., 15 fps) (details of this operation are well known and will not therefore be described.). Image data of each of frames thus generated (frame image data) is captured into the image-data memory 56 through the analog-to-digital conversion part 28.

[Step S6]

The continuous shooting at step S5 is performed until the fully pressed release button is released. With the release, the process proceeds to step S7. Even before the release from the full press on the release button, the continuous shooting is terminated if the amount of the captured image data reaches the capacity of the image-data memory 56.

[Step S7]

The MPU 40 terminates the continuous shooting in synchronism with the release from the full press on the release button. Then, the image processing part 52 performs image processing such as white balance adjustment, gamma correction, and color interpolation processing on the entire frame image data generated by the continuous shooting. Thereafter, image data in each frame is captured into the image-data memory 56 again. The process then proceeds to step S8.

[Step S8]

The MPU 40 reads a user's setting to determine in which of the following two manners frame image data is extracted for a composite image. In a difference reflecting extraction, the process proceeds to step S11. In a uniform interval extraction, the process proceeds to step S9. In the difference reflecting extraction, the smaller differences between frames (to be described later) are, the longer image extracting intervals are. In the uniform interval extraction, extraction is performed at such intervals that intervals at which each frame image of extracted image data has been shot become substantially uniform.

[Step S9]

The MPU 40 determines the number of the frames generated by the continuous shooting at step S5 (hereinafter referred to as number of shot frames). The user can increase or decrease the number of shot frames as he or she wishes by operating the release button.

The MPU 40 determines image extracting intervals according to the number of shot frames and the number of arranged frames which has been set in advance through a user's operation or the like. The number of arranged frames used herein refers to the number of frames that are arranged in one composite image in the multi-shooting mode. The image extracting intervals refers to intervals at which the extraction is performed for all of the frames of image data generated by continuous shooting to extract the frames of image data to be used for a composite image. For example, in a case where every fourth frame is extracted, the image extracting intervals are three.

For example, the image extracting intervals may be set to values which are obtained by subtracting one from a value obtained by dividing the number of shot frames by the number of arranged frames. When it is necessary to extract the image data of the first and last shot frames, for example, the image extracting intervals may be set to values which are obtained by subtracting one from a value obtained by dividing (the number of shot frames minus one) by (the number of arranged frames minus one). The process then proceeds to step S1 0.

[Step S10]

The MPU 40 extracts frame image data according to the image extracting intervals.

For example, assume that the image data of the first and last shot frames is to be extracted where the number of shot frames is 61 and the number of arranged frames is 16. Then, the extracting intervals will be three so that the first, fifth, ninth, . . . and sixty-first frames are required to be extracted. The process then proceeds to step S14.

[Step S11]

The MPU 40 selects frames for which differences between frame images are to be calculated according to the number of shot frames and the number of arranged frames. A difference between frame images is a parameter representing the amount of a variation in an object between frame images and will be calculated at the next step S12.

The present embodiment describes an example that image data of all of frames excluding the first frame is selected when a value obtained by dividing the number of shot frames by the number of arranged frames is smaller than a predetermined value. When the value thus obtained is equal to or greater than the predetermined value, image data of all of the frames other than the first frame is decimated at an interval according to the obtained value. Then, image data of remaining frames is selected. For example, when the obtained value is twice the predetermined value, every other frame is selected. When the obtained value is three times the predetermined value, every third frame is selected. Note that the number of frames of image data thus selected is at least equal to the number of arranged frames, and the shooting is performed at substantially uniform intervals.

For example, in a case where it is determined to select every third frame, the image data of the first and fourth frames is compared with each other to obtain a difference therebetween that is associated with the fourth frame. Similarly, the image data of the fourth and seventh frames is compared with each other to obtain a difference therebetween that is associated with the seventh frame. That is, image data of frames used for the comparison to calculate the difference is image data of frames, among the selected image data, which has been shot immediately prior to the frame for the subject of the calculation or the image data of the first frame.

The difference between frame images may be obtained for the image data of all of the frames excluding the first frame regardless of the number of shot frames and the number of frames arranged in one composite image. The process then proceeds to step S12.

[Step S12]

The MPU 40 calculates the difference between frame images for the frame image data selected at step S11. Specifically, the pixel value of each pixel of frame image data as 20 subject of the comparison is subtracted from the pixel value of each pixel of frame image data for which a difference between frame images is calculated. One frame of image data thus generated is defined as difference image data. In the present embodiment, since color interpolation is performed at step S7, the pixel value is the digital data of the color component including the greatest amount of luminance information among digital data of respective color components. That is, the speed of the processing is increased by not processing the digital data of unneeded color components.

The sign of each pixel value of the difference image data is reversed if it has a negative value. Then, the sum of all of the pixel values of the difference image data is obtained as a difference between frame images. The process thereafter proceeds to step S13.

Alternatively, digital data of a plurality of color components of each pixel may be processed. For example, difference image data is generated by subtracting the pixel values of first and second color components of each pixel of single frame image data to be used for comparison from the pixel values of the first and second color components of each pixel of single frame image data for which a difference between frame images is to be calculated, respectively. Then, any of the pixel values of the first and second color components having a negative value is subjected to sign-reversal. The sum of all pixel values of the first and second color components of the difference image data may be used as a difference between frame images.

[Step S13]

The MPU 40 extracts image data corresponding to the number of arranged frames from the image data selected at step S11 in ascending order of differences between frame images. The present embodiment, however, describes an example that the extraction is performed such that the data extracted include data of the first frame (difference between frame images is not calculated for the first frame).

Alternatively, it may be configured that the image data of the first and last shot frames is always extracted regardless of whether the frames are subjects for the calculation of the difference between frame images. Further, the extraction may be performed only on the frame image data selected at step S11 without extracting the first frame.

The process thereafter proceeds to step S14.

[Step S14]

The MPU 40 arranges the frame image data extracted (at step S10 or S13) on the image-data memory 56 to create image data of a composite image (composite image data).

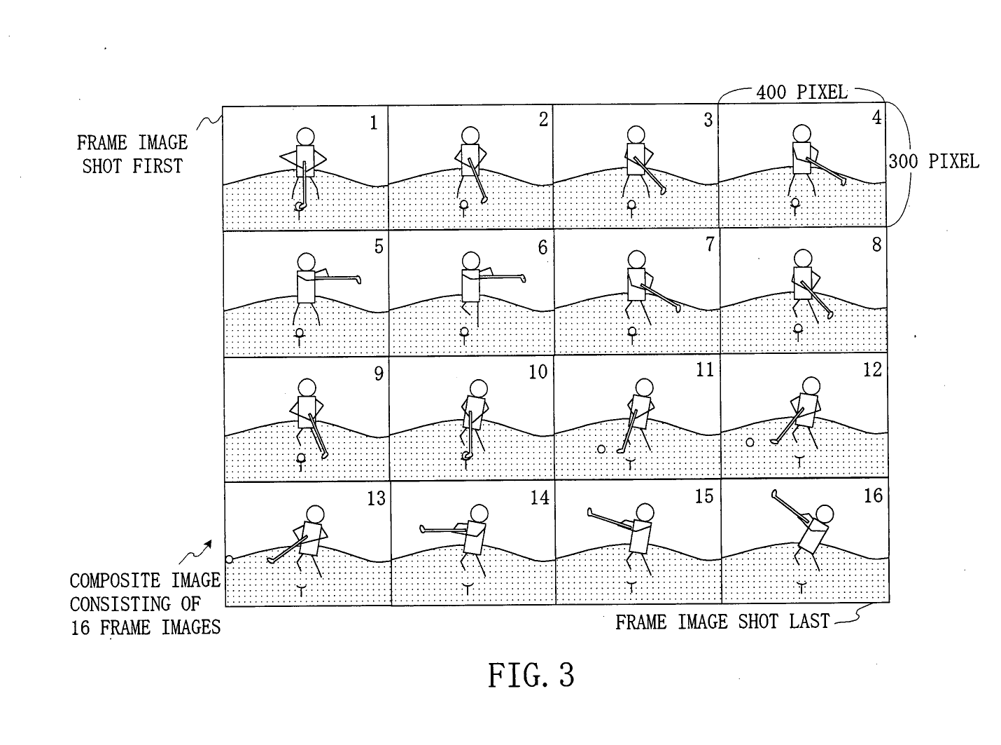

The arrangement is made in an order in accordance with the times at which they are shot, and the earlier the time, the earlier the order. For example, the frame images are arranged in the order, starting from a first shot frame, in a top left position which is followed by top right, middle left, middle right, bottom left, and bottom right positions. FIG. 3 is an illustration showing an example of a composite image created in such a manner.

For example, assume that the size of a single frame image in a composite image is vertical 240 pixels×horizontal 320 pixels and that the number of arranged frames is 16. Then, the size of the composite image will be vertical 960 pixels×horizontal 1280 pixels. When the size of the composite image is smaller than a predetermined size (e.g., vertical 1200 pixels×horizontal 1600 pixels), the MPU 40 instructs the image processing part 52 to perform interpolation processing on the composite image data to enlarge it to the predetermined size.

After converting the composite image data into that of the predetermined size, the image processing part 52 further performs processings such as color conversion, color correction, contour enhancement, and image compression. Then, the image processing part 52 records the compressed composite image data in the memory card 68 through the card interface 64. The recording may include recording of supplementary information indicating by how many seconds the shooting time of each frame image has delayed from a time t=0 at which the first frame has been shot. The MPU 40 deletes frame image data which have not been extracted from the image-data memory 56.

Operations of the electronic camera of the present embodiment are as described above.

### ADVANTAGES OF THE EMBODIMENT

The multi-shooting mode of the present embodiment includes two functions, i.e., uniform interval extraction and difference reflecting extraction, and image data of a plurality of frames is generated by continuous shooting while the release button is fully pressed by a user.

While the uniform interval extraction is set, image data of frame images to be arranged is extracted from the generated frame image data at such intervals that intervals at which the frame images have been shot become uniform (step S10). Therefore, the first frame image of the composite image is the image shot at the instant when the release button is fully pressed by the user. Similarly, the last frame image of the composite image is the image shot at the instant when the full press on the release button is released. As a result, the total shooting time can be arbitrarily set through an operation of the user even with a fixed frame rate of the CCD 20.

Specifically, when a swing of a golf club is shot, the total shooting time can be adjusted to the time from the start to end of the swing. This solves the problem that a generated composite image includes only frame images shot up to a point halfway the swing because the shooting terminates before the swing ends. Similarly, it is possible to solve the problem that a generated composite image includes unnecessary frame images taken after the swing ends because the swing terminates before the shooting ends.

While the difference reflecting extraction is set, selection is performed such that the number of frame images whose data is selected is equal to or more than the number of arranged frames, and the intervals at which frame images have been shot become substantially uniform (step S11). Differences between frame images are obtained for the selected frame image data, and the frame images are selected in ascending order of the obtained differences (steps S12 and S13). This solves the problem that a generated composite image includes unnecessary frame images which are substantially the same as their preceding and succeeding images. As a result, as shown in FIG. 3, it is able to create a composite image which clearly captures motions of the object.

If frame image data extraction is performed such that the first and last shot images are extracted without fail, the user can determine the total shooting time through a release button operation in the same way as in the uniform interval extraction.

### SUPPLEMENTARY NOTES FOR PRESENT EMBODIMENT

[1] In the present embodiment, an example was described in which the sum of all pixel values of difference image data is obtained as a difference between frame images (step S12). The invention is not limited to such an embodiment. Pixels having absolute pixel values equal to or greater than a preset threshold may be counted among the difference image data, and the count value may be used as a difference between frame images. The count value represents the area of portions which show a change from the preceding frame image or a movement of the object.

[2] An example was described in which data of frame images to be arranged is extracted from frame image data selected at step S11 as a subject for calculation of differences between frame images. The invention is not limited to such an embodiment. When there is frame image data having a great difference between frame images, frame image data preceding and succeeding thereto and not selected as an subject for calculation of the differences may be extracted and used for generation of a composite image.

[3] An example was described in which the frame image data to be used for generation of a composite image is extracted using either uniform interval extraction or difference reflecting extraction. The invention is not limited to such an embodiment. For extraction of frame image data to be used for a composite image, for example, random extraction, starting time extraction, middle time extraction, ending time extraction, X-th power extraction, or the like may be made selectable depending on a user's purpose.

In the random extraction data is extracted at random from all of the frame image data generated by continuous shooting.

In the starting time extraction, for only a certain percentage of frame images shot at the start of shooting the extraction is performed at such intervals that intervals at which the frame images have been shot are shorter than intervals at which the rest of the frame images have been shot. The percentage may be determined by the user's input, for example. This way of extraction is advantageous when motions of the object at the beginning of shooting have greater importance.

In the middle time extraction, for only a certain percentage of frame images shot at the middle of shooting the extraction is performed at such intervals that intervals at which the frame images have been shot are shorter than intervals at which the rest of the frame images have been shot.

In the ending time extraction, for only a certain percentage of frame images shot at the end of shooting the extraction is performed at such intervals that intervals at which the frame images have been shot are shorter than intervals at which the rest of the frame images have been shot.

The X-th power extraction is performed such that times at which extracted frame images have been shot will be values as a series of X-th powers (the value X is input by the user) at an instant when the object starts moving is zero (a starting point).

For example, in case of shooting a rubber balloon which is expanding while being injected with a liquid at a constant flow rate, from the start of the injection or immediately prior to the start, the frame images are extracted such that times at which the frame images have been shot will be values as a series of third powers when the injection starting time is zero (a starting point). Specifically, where the injection starting time (the shooting time of the first extracted frame) is t=0, the extraction is performed such that the shooting time of the second extracted frame is t=1; the shooting time of the third extracted frame is t=8; the shooting time of the fourth extracted frame is t=27; the shooting time of the fifth extracted frame is t=64; and so on (the unit of the time t is determined according to the total shooting time, the number of shot frames, and the number of arranged frames). The reason is that it is assumed that the diameter of the rubber balloon increases in proportion to the one-third power of injecting time because the volume of the diameter of the rubber balloon increases in proportion to injecting time. Thus, increases in the diameter of the rubber balloon between the extracted frame images can be shown at uniform intervals.

For example, assume that an object dropping at a predetermined acceleration is shot with a sufficient distance from the instant when it starts dropping or immediately before the instant. Then, the extraction of frame images is performed such that their shooting times constitute a series of square roots. Specifically, where the drop starting time (the shooting time of the first extracted frame) is t=0, the extraction is performed such that the shooting time of the second extracted frame is t=1; the shooting time of the third extracted frame is t=\sqrt{2}; the shooting time of the fourth extracted frame is t=\sqrt{3}; the shooting time of the fifth extracted frame is t=2; and so on. Thus, the amounts of movements between the extracted frame images can be shown at uniform intervals.

A way of extraction may be selected after checking motions of an object after the completion of the shooting. Alternatively, the selection may be done before the shooting.

[4] An example was described in which one item of composite image data is created from extracted frame image data and the created composite image data is recorded. The invention is not limited to such an embodiment. Each item of extracted frame image data may be separately recorded without creating composite image data. That is, the invention may be applied to continuous shooting modes other than the multi-shooting mode, and advantages similar to those described above can be also achieved.

[5] At steps S4 to S6, an example was described in which continuous shooting is performed from the full press on the release button to the release from the full press. The invention is not limited to such an embodiment. For example, continuous shooting may be started in synchronism with a full press on the release button and terminated in synchronism with another full press thereon after the full press is once released.

What is claimed is:

1. An electronic camera having a multi-shooting mode in which data of a single composite image is generated by arranging and compositing data of a predetermined number of images generated by continuous shooting, comprising:
a release switch for instructing execution of a shooting operation;
an image pickup part that performs the continuous shooting according to an operation to said release switch to generate data of a plurality of images in said multi-shooting mode;
an extraction processing part that changes an extracting rate according to the number of images generated by said image pickup part, and extracts the data of the predetermined number of images from the data of the plurality of images according to the changed extracting rate; and
an image composition part that arranges and composites the data of the predetermined number of images extracted by said extraction processing part to generate the data of the single composite image.

2. The electronic camera according to claim 1, wherein said extraction processing part performs the extraction at such intervals that intervals at which images in extracted data have been shot become substantially uniform.

3. An electronic camera having a multi-shooting mode in which data of a single composite image is generated by arranging and compositing data of a predetermined number of images generated by continuous shooting, comprising:
a release switch for instructing execution of a shooting operation;
an image pickup part that performs the continuous shooting according to an operation to said release switch to generate data of a plurality of images in said multi-shooting mode;
a variation calculating part that calculates a difference between frame images in the data of the images generated by said image pickup part, the difference representing an amount of variation in an object;
an extraction processing part that extracts data of the predetermined number of images from the data of the plurality of images at such intervals that the smaller the difference between the frames images, the longer the intervals; and
an image composition part that arranges and composites the data of the predetermined number of images extracted by said extraction processing part to generate the data of the single composite image.

4. The electronic camera according to claim 3, wherein said extraction processing part extracts the data of the predetermined number of images in ascending order of the calculated differences.

5. An electronic camera having a multi-shooting mode in which data of a single composite image is generated by arranging and compositing data of a predetermined number of images generated by continuous shooting, comprising:
a release switch for instructing execution of a shooting operation;
an image pickup part that performs the continuous shooting according to an operation to said release switch to generate data of a plurality of images in said multi-shooting mode;
a variation calculating part that selects the data of the predetermined number or more of images from the data of the plurality of images according to the number of images generated by said image pickup part, and calculates a difference between frame images in the selected data, the difference representing an amount of variation in an object;
an extraction processing part that extracts the data of the predetermined number of images from the data of the plurality of images at such intervals that the smaller the difference between the frame images, the longer the intervals; and
an image composition part that arranges and composites the data of the predetermined number of images extracted by said extraction processing part to generate the data of the single composite image.

6. An electronic camera having a multi-shooting mode in which data of a single composite image is generated by extracting data of a predetermined number of images from data of a plurality of images generated by continuous shooting, and by compositing the extracted data of the images, comprising:
a release switch for instructing execution of a shooting operation;
an image pickup part that performs the continuous shooting according to an operation to said release switch to generate data of the plurality of images in said multi-shooting mode;
an extraction processing part that extracts the data of the predetermined number of images from the data of the plurality of images in said multi-shooting mode at such intervals that an Nth frame image data to be extracted is generated by shooting at a time of an Xth power of (N-1) where X is more than zero when a first frame image data to be extracted is assumed to be generated by shooting at a time zero; and
an image composition part that arranges and composites data of the predetermined number of images extracted by said extraction processing part to generate the data of the single composite image.

7. An electronic camera having a multi-shooting mode in which data of a single composite image is generated by arranging and compositing data of a predetermined number of images generated by continuous shooting, comprising:
a release switch for instructing start and end of the continuous shooting in said multi-shooting mode;
an image pickup part that performs the continuous shooting according to an operation to said release switch to generate data of a plurality of images in said multi-shooting mode;
an extraction processing part that extracts data of the predetermined number of images from the data of a plurality of images in said multi-shooting mode in such a manner that the data extracted includes data of images shot at the start and end of the continuous shooting; and
an image composition part that arranges and composites the data of the predetermined number of images extracted by said extraction processing part to generate the data of the single composite image.

8. The electronic camera according to claim 7, wherein the extraction processing part changes an extracting rate according to the number of images generated by said image pickup part and extracts the data of the predetermined number of images from the generated data of the images according to the changed extracting rate.

9. The electronic camera according to claim 7, further comprising a variation calculating part that calculates a difference between frame images of the generated data of the images, the difference representing an amount of variation in an object, wherein
said extraction processing part extracts the data of the predetermined number of images from the data of the plurality of images at such intervals that the smaller the difference between the frame images, the longer the intervals.

10. A method for generating data of a single composite image by arranging and compositing data of a predetermined number of images generated by continuous shooting, comprising the steps of:
generating data of a plurality of images by continuous shooting;
changing an extracting rate according to the number of images generated and extracting the data of the predetermined number of images from the generated data of the images according to the changed extracting rate; and
generating the data of the single composite image by arranging and compositing the extracted data of the images.

11. A method for generating data of a single composite image by arranging and compositing data of a predetermined number of images generated by continuous shooting, comprising the steps of:
generating data of a plurality of images by continuous shooting;
calculating a difference between frame images in the generated data, the difference representing an amount of variation in an object;
extracting the data of the predetermined number of images from the generated data of the images at such intervals that the smaller the difference between the frame images, the longer the intervals; and
generating the data of the single composite image by arranging and compositing the extracted data.

12. A method for generating data of a single composite image by arranging and compositing data of a predetermined number of images generated by continuous shooting, comprising the steps of:
generating data of a plurality of images by continuous shooting;
selecting data of the predetermined number or more of images from the generated data of the images according to the number of images generated, and calculating a difference between frame images in the selected data, the difference representing an amount of variation in an object;
extracting data of the predetermined number of images from the generated data of the images at such intervals that the smaller the difference between the frame images, the longer the intervals; and
generating the data of the single composite image by arranging and compositing the extracted data of the images.

13. A method for generating data of a single composite image by extracting data of a predetermined number of images from data of a plurality of images generated by continuous shooting and by compositing the extracted data of the images, comprising the steps of:
generating data of a plurality of images by continuous shooting;
extracting the data of the predetermined number of images from the data of the plurality of images at such intervals that an Nth frame image data to be extracted is generated by shooting at a time of an Xth power of (N-1) where X is more than zero when a first frame image data to be extracted is assumed to be generated by shooting at a time zero; and
generating the data of the single composite image by arranging and compositing the extracted data of the images.

14. A method for generating data of a single composite image by arranging and compositing data of a predetermined number of images generated by continuous shooting, comprising the steps of:
instructing start and end of the continuous shooting;
generating data of a plurality of images by the continuous shooting according to the instruction;
extracting the data of the predetermined number of images from the data of the plurality of images in a such manner that the data extracted includes data of images shot at the start and end of the continuous shooting; and
generating the data of the single composite image by arranging and compositing the extracted data of the images.
